(19) United States
(12) Patent Application Publication
(10) Pub. No.: US 2002/0082858 A1
(43) Pub. Date: Jun. 27, 2002

(54) Managing distribution and local execution of computing resources

(75) Inventors: Abdelsalam A. Heddaya, Lexington, MA (US); Sulaiman A. Mirdad, Riyadh (SA)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: InfoLibria, Inc., Waltham, MA (US)

(21) Appl. No.: 09/950,981

(22) Filed: Sep. 12, 2001

Related U.S. Application Data
(60) Provisional application No. 60/232,016, filed on Sep. 12, 2000.

(51) Int. Cl. G06F 17/60

(52) U.S. Cl. 705/1

(57) ABSTRACT

A configuration management service in a client-server data processing system that manages distribution and installation of different versions and formats of resources so that they remain compatible with each other. When the resources are application programs, the service only distributes combinations of applications that are compatible with one another. This provides the advantages of local execution of application programs on a client computer while at the same time providing the advantages of managed configuration from the central server location. The applications continue to run on the clients and network hosting is not used. The service thus separates execution of applications from the control over their distribution. In a preferred embodiment, a hierarchical, networked cache storage arrangement is used to coordinate the actual physical storage and distribution of the resources as demands are made for them. Profile information maintained for particular users of the service may control how much control over the local file system is given to the service, implementation of different purchase options and different administrative preferences. The invention permits the implementation of a new and cost effective business model for the distribution of software to users that might not necessarily consider it to be cost effective to otherwise make use of such applications, in addition to affording more predictable behavior of installed applications and content.

### RELATED APPLICATION(S)

This application claims the benefit of U.S. Provisional Application No. 60/232,016, filed on Sep. 12, 2000, entitled “Method and Apparatus for Providing Content Banking for Allcache Devices,” which is hereby incorporated by reference in its entirety.

### BACKGROUND OF THE INVENTION

Architectures for supporting user access to data processing systems have evolved significantly over the past several decades. From a timesharing mainframe computing environment most popular in the late 1960's, there was a profound shift to the use of personal computing (PC) systems during the early 1980's. In the PC model, application programs run on desktop devices that are largely installed and run under the control of individual users.

There are a number of difficulties with pushing application execution to the desktop. In particular, a model where users can simply buy software off the shelf and are left to install and configure such software on their own leads to a host of problems. There is the problem of not only insuring compatibility of specific hardware devices with particular applications, but also with compatibility among the different applications themselves. For example, some applications may not be compatible with certain later versions of operating systems. Likewise, certain applications may themselves not be compatible with the deployment of other applications on the same machine with which they need to communicate. Applications that require the use of special hardware devices, such as graphics, processors, or game controllers, may have compatibility conflicts with the device drivers causing conflicts in peripheral device drivers and the like.

Another list of problems relate to file format compatibility with software applications for viewing or manipulating these files. Examples include video formats, document formats (PDF, Postscript, DOC, compressed archives (e.g., ZIP, etc.).

Because of these limitations in the deployment of applications at the desktop, and for other reasons such as performance, there evolved a client-server type computing model. With this architecture, applications run on centralized server computers. The servers are connected via networking technologies to client PC computers for data transfer; the PCs thus serve principally as user interfaces.

Most recently the proliferation of internetworks and public networks, exemplified by Internet, have resulted in yet another computing model, which is the so called Application Service Provider (ASP) model. This approach uses central server computers to provide a contractual service offering to deploy, host, manage and, in effect, rent access to software applications from a centrally managed facility.

The client-server and ASP models do alleviate certain difficulties associated with application deployment on the desktop. Providing centralized access to critical applications can be quite cost effective, especially in a business environment, where many users share access to the identical application programs. This model also provides for centralized and uniform deployment of applications which then alleviates problems with version control, remote support, multiple different system configurations and data replication issues. When confronted with thousands of uses in an organization, the cost of application ownership can therefore be effectively controlled by these models for enterprise wide deployment.

However, the situation is still quite difficult for the personal or home computer user as well as for certain types of business users. These users are still left to their own devices in installing software applications, ensuring compatibility among versions, and dealing with any conflicts or other issues which may arise in their installation and execution.

Similarly situated is a business user, for example, located in a small enterprise or in a satellite office of a larger business, who do not have the resources of a corporate information technology professional to oversee installation of their application programs. Other problems are presented to the home user with only a dial-up connection to a network, or a business user who may be on the road often and relying principally on laptop, handheld or other portable computing devices with no or slow-speed wired or wireless network connections. These users do not have access to centralized ASP or client server computing model at all, since their network connections do not support it.

Because they lack access to high bandwidth networks and powerful desktop computers, or a corporate information technology staff, these classes of users are left presently to their own devices to install desktop applications, and troubleshoot the inevitable conflicts among application versions and vendors.

In addition, it appears as though the standard software distribution model for desktop applications themselves is becoming mature. There seems to be a particular price point in the range of $50 to $200 for most personal computer applications. While a certain subset of the public does have the financial resources to pay for such application software on a per machine license or “shrink wrap” basis, another subset of computer users are positioned at a lower end of the economic scale. They do not have the resources to pay, say $500 to equip a personal computer with the software that they may only need for limited periods of time. Furthermore, such low end users may not need access to all of the advance features that a typical modem software application such as a word processor program provides. Indeed, most PC users probably make use of a very limited subset of features most of the time and advanced features such as for example, graphics editing, equation editing, grammar checking, automatic formatting, and other similar features may only be used a very small part of the time.

Unfortunately, the shrink wrap distribution model forces the software producer to price their packages to be designed for use by the average user. As a result, the market has become somewhat limited for reaching a lower end economic model.

The mass market for application software could potentially reach additional customers if other distribution models were used. But these models should not necessarily have to rely on available or high-speed network connection as is the case in client-server or ASP computing models. These models could also take advantage of functionality built in to the desktop computer itself in the control and optimization of the over distribution and installation of software applications.

### SUMMARY OF THE INVENTION

The present invention is directed to a technique for providing managed distribution and configuration of data processing resources. The resources may include applications and data, typically involving different versions of the same application and different file formats for the data. Data may include not only multimedia data files (video, audio, and images) but also documents (books, articles, papers) and user data (spreadsheets and databases). The technique makes use of a Configuration Manager (CM) process executing in a extended service provider (XSP) location which may, for example, be implemented as one or more network file servers. The configuration manager stores multiple versions of many different types of data processing resources that may be requested to be installed by subscribers to the service. The CM cooperates with an interposer layer installed in a client computer. When a user attempts to execute or access a selected data processing resource, the interposer layer intercepts storage system calls for the asset, directing them to the configuration manager. The configuration manager then directs the request to an appropriate storage location, such as may be in a managed hierarchy of cache storage devices.

In one embodiment, the configuration manager maintains versions vectors for each of many possible but compatible configurations of software applications to be distributed. For example, one version vector may list a particular combination of an operating system version and one or more compatible application software versions, such as a word processor version and a database program version that are compatible with one another, and with the operating system version. Upon a request for a provisioning by a customer, such as when the customer's PC is booted on or initially configured, the configuration manager executes a process to determine a version vector that is most consistent with the customer request, while still meeting version compatibility constraints. For example, the version vector that contains the most recent versions of application programs that are consistent with the user's request will be selected.

The configuration manager typically maintains information concerning each user as a user profile record. The user profile indicates information containing the scope of file system control that the user wishes to delegate to the configuration manager, purchase options that have been selected for particular applications, a list of the applications themselves and other administrative information such as administrative preferences for the particular user. For example, given user may select a purchase option that is on a per machine copy, on a per use basis, or a subscription. The purchase option may also include additional information that for example, select from a number of different available editions of a selected application, wherein each edition enables a certain feature subset for that application.

Similarly, in the context of multimedia content distribution, the service profile for a user may have associated with it a list of allowed multimedia content types that are supported by the applications associated with the version vector assigned to that user. A file format conversion function can assist users with moving data between applications and devices without being obstructed by format incompatibility.

In a preferred embodiment, the configuration manager also has associated with it a mechanism for storage of authoritative copies of all the resources that may be subscribed to by the users. The authoritative resource content may for example include stored copies of all versions and all editions of all supported application programs. Thus, for an operating system such as Microsoft Windows, the resource storage may have associated with it copies of Windows version 3.1, Windows 95, Windows 98, Windows 2000, Windows XP, Windows ME, Windows NT, and so on. The resource storage may also include multiple versions of application software such as for example, Microsoft Word. In such instance, the resource storage may include authoritative copies of Microsoft Word version 6, Word 95, Word 97, Word 2000, Word XP, and so forth. Also, this resource storage may include authoritative copies of all data files generated, purchased, or collected by the user.

The authoritative resource storage mechanism is made available in a distributed fashion through a networked data storage device that can be accessed not only by the configuration manager, but also by processes executing at the client computer. The authoritative resource storage may be bulk file server type storage or logical disk volume type storage, depending upon the particular environment in which the invention is being deployed.

Most commonly, a network file system type model will be chosen such that the resource storage is a bulk file server that can be accessed through bulk network data transfer protocols such as Transmission Control Protocol/Internet Protocol (TCP/IP) and the higher layer File Transfer Protocol (FTP), Hypertext Transfer Protocol (HTTP) and other well known networking protocols for Internet file transfer.

In other environments, such as local area or metro-area networks, a Network File System (NFS), or a logical disk volume type storage may be utilized for the resource storage.

The configuration manager controls user requests for version updates in a manner which is consistent with their known compatibility. For example, a user may request an upgrade of his word processor to Microsoft Word Version ‘XP’. However, he may presently be running a version of an operating systems such as Windows 95 that is incompatible with such a version upgrade. In such an instance, the configuration manager would not be able to find a version vector that matches, and therefore deny the request for the user for an upgrade. Depending upon administrative preferences as selected by the user, the user may be prompted to see if at that time he wishes to pay for the additional fee associated with a version upgrade of the operating system as well. This avoids a situation then where a user is upgrading an application program such as a word processor, without taking into account ramifications that may exist with other existing installed software.

This feature can be used to not only prevent upgrades by users that can become incompatible with existing software but also to prevent the installation of newer versions of software which may not have drivers or compatibility with existing applications. For example, a user may request upgrade from Windows 98 to Windows 2000. However, the user may have installed a database application that operates with a particular peripheral such as a Palm Pilot hand held computer. A device driver for the handheld exists for Windows 98, but no such driver exists for Windows 2000. The user would then be alerted to the possible undesirability of installing the upgraded operating system software.

The configuration manager is responsible for not only maintaining version configuration and edition configuration information for each of the resources requested by each user of the system but also other functions associated with supporting these users on a subscription basis. These functions may include registration, authorization, authentication, and accounting for various services that users select.

In addition, the system provides for distribution of service patches in a managed fashion, for example, should a patch become available for a particular version of an operating system, the service patch can be distributed in an orderly fashion and restricted only those version vectors for which it is known that the patch upgrade will maintain existing compatibility.

In order to support the distribution of resources by the configuration manager, there is also a modification needed for the operating system and file system layers in the client-side computer. In particular, an interposer layer is associated with the file system at the client-side computer which intercepts all requests made to the local storage device at the client, and which is cognizant of the remote resource distribution service provided by the configuration manager.

The interposer may initially use an auto-discovery protocol at the time of instantiation to determine if the service is available. If the service is detected, the interposer first executes appropriate processes for registration, authentication and administration of the service.

The interposer will then receive stub information for any applications and data that are to be installed from the configuration manager. The stubs themselves are installed as a next step. A particular service mode indicator will be looked at at this point to determine if the user is expecting to run in a connected or disconnected mode. If the disconnected mode is the selected mode, the resources associated with the users' version vector will be downloaded to a local storage cache. The resources required for use in disconnected mode will be labeled as pinned for the particular installed applications. Should there not be sufficient local storage resources to install all of the requested applications, a prioritization process will be executed based on user preferences.

If however, the user is to run in a connected mode, the stub information will be used to set up a local storage as a persistent cache memory. Decisions to store application software of even components of application software will be made on a performance basis. For example, an algorithm such as Least Frequently Used (LFU) can be used to eject application components that are not pinned from the non-authoritative but persistent local cache.

The interposer at the user location is also responsible for maintaining configuration management information peculiar to the particular user, maintaining control information that is necessary to communicate its present state to the configuration manager and for ensuring that the correct file versions are always used that are compatible with existing installed applications, and manages its local cache memory.

The invention therefore provides for the use of distributed cache memory to support a management service that may be used to manage the configuration of the resources such as installed applications and data. The distribution of applications and content in this manner supports a new marketing model that allows software producers to distribute new versions or changes in their applications to end users in a much more flexible model than is available through the shrinkwrap software model.

Indeed the flexibility associated with Application Service Providers and/or client server computing models that are well known in corporate organizations can now be made available to the users of personal computers and home locations and/or the occasional or satellite located business user that previously only had to rely on shrinkwrap software models.

In addition, such end users can be charged on a per use or level of functionality desired basis without the need to maintain a continuous high speed connection to a network host. In effect, the distribution model separates data from the control over the data in an application service provider model. This provides all of the benefits of high* speed execution on the client computers, while at the same time maintaining the configuration control advantages provided by a client-server or ASP model, without the need for maintaining high speed continuous network connections between a client and a network application host or server.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a system level diagram for implementing a configuration management service according to the present invention.

FIG. 2 is a more detailed diagram of a file system network driver and disk controller layers in the user data processor.

FIG. 3 is a flow diagram for a sequence of steps performed by an interposer layer at the client.

FIG. 4 is a flow diagram of steps performed by an interposer layer and a configuration management layer to execute applications.

FIG. 5 is a flow diagram of a sequence of steps performed by the interposer layer and a configuration management layer to insure compatibility of resource content files among different applications.

### DETAILED DESCRIPTION OF A PREFERRED EMBODIMENT

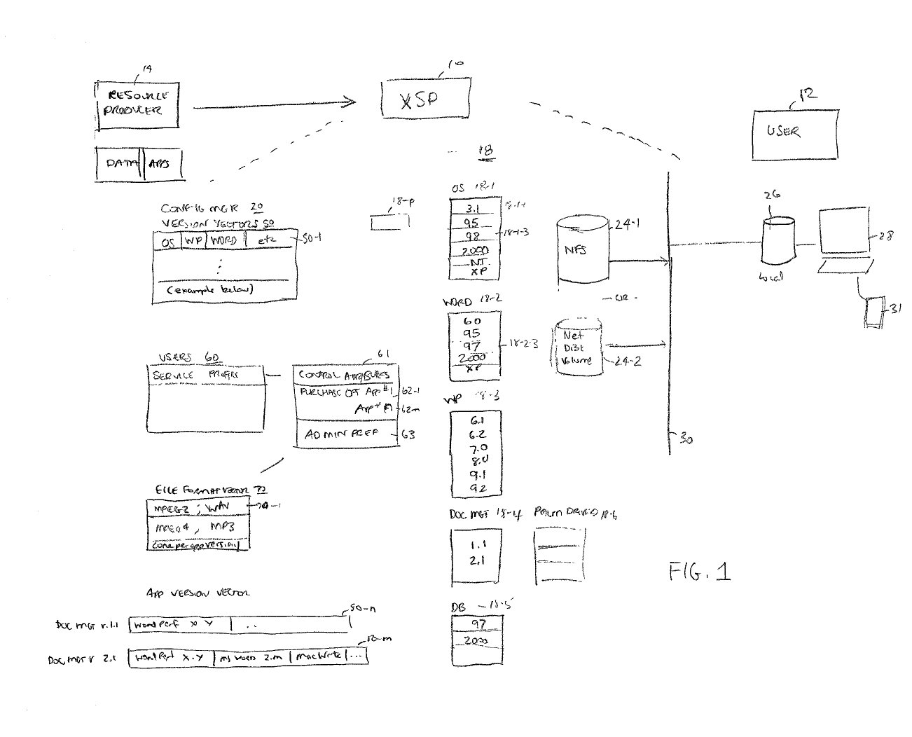

FIG. 1 is a system level diagram of elements of a distributed data processing system that implements a configuration management service in accordance with the present invention. The configuration management system may be used to manage the distribution of various computing resources, such as computer programs and/or content files, in a coordinated fashion to ensure compatibility among installed resources without intervention by an end user. The system uses a server computing model for installing and configuring resources, but allows the client computer to maintain local control over execution and use of the resources. Access to installed resources may be controlled through a managed cache hierarchy, or simply using a centralized server.

Elements of the configuration management service are principally implemented by one or more server computers 10 located at a service provider. The service provider is referred to herein with the terminology “XSP” to indicate that it may be physically instantiated in a number of different ways. For example, the “XSP” may be a so-called Internet Service Provider (ISP), Network Service Provider (NSP), Application Service Provider (ASP), or located in any other type of distributed computing environment in which a central data processing system or server 10 may communicate messages and exchange data with a number of connected end user or client computers 12.

A number of different resource producers 14 provide copies of applications software, operating systems, content files such as multi-media files and other data processing elements for which the configuration is to be managed by the system. These various elements or more correctly resources 18 are provisioned for in the system. In particular, a configuration manager 20 controls distribution and access to a given resource 18 in a manner such that its distribution to particular end users remains compatible with the distribution of other resources 18 to the same user 12. More specifically, particular versions of resources 18 will not be deployed for particular users 12 unless they are compatible with other resources 18 already allocated to or requested by the user 12.

It should be assumed that in any practical computing environment the resources 18 will encompass a number of different elements such as operating systems, application programs, and even data file formats. For example, a number of different versions of the Microsoft Windows operating system 18-1 may be made available. Different word processing programs such as Microsoft Word 18-2 or Corel Wordperfect 18-3 will typically also be stored as resources 18. A document management application program 18-4 and a database program 18-5 are also associated with a particular example being discussed.

A given resource 18 may have a number of versions. For example, in the case of resource 18-1 such as the Microsoft Windows Operating System, there may be one resource 18-1-1 that is a copy of Windows 3.1, and other resources may be Windows 95, Windows 98, Windows 2000, Windows NT, and Windows XP.

In addition each version of a resource 18 may have associated with it a number of different editions. For example, Windows 98 resource 18-1-3 may have associated with it a number of different editions (not show in FIG. 1) correspond to particular instantiations of the resource that have different subsets of features enabled. For example, a stripped down version of a resource such as Microsoft Word 97 18-2-3 may have only the most commonly used word processing functions such as file creation, text entry, copy, paste, and simple text formatting commands.

Another edition of Word 97 18-2-4 may have additional features such as equation editing and graphic drawing features installed.

All of the resources 18 are stored in a distributed file system such that they may be accessed both by the servers 10 at the XSP 10 as well as the remotely located users 12. In the most common embodiment, the file store will be a network file system 24-1 as shown. This can be implemented as a bulk type file server commonly associated with distributed network access such as a web-based file server. The network file server 24-1 participates in and allows access to elements stored within it through the use of commonly available network file protocols such as the File Transfer Protocol (FTP), Hyper Text Transfer Protocol(HTTP), or other well known bulk file transfer protocols.

Alternatively, however, the resources 18 may be stored in a network disk volume 24-2 that may be accessed by both the server at the XSP 10 and the user computers 12. For example, this may be network storage device that is addressable as a disk volume in a local area network or a metro area network type configuration. It should be understood, of course, that certain resources 18 may be resident on the network file server 24 or in the network disk volume 24-2 or some combination thereof. However, again, it should be understood that in most implementations a network file server 24-1 will typically be preferable, especially to support users 12 that have only limited access to the XSP 10 through, for example, a dial up connection.

The user 12 have associated with them a central processing unit 28 as well as local disk storage 26. The users 12 are connected through a network infrastructure 30 to the XSP 10. The network infrastructure 30 maybe any convenient local or wide area network infrastructure connections. However, in the preferred embodiment it should be understood that the network infrastructure 30 is typically a dial up network, a wireless network or other network which provides only limited bandwidth access between the user 12 and the resources 18 located at the XSP. Thus, for example, the network connection 30 may be a dial up connection through a telephone network such that the user 12 need not be always connected to the XSP in order to execute applications.

The network volumes 24 operate as an authoritative, hierarchical, caching system. Thus, for example, the authoritative copies of the elements 18 are stored in the network storage devices associated with the XSP. The local volumes 26 operate as a non-authoritative persistent cache that is synchronized on a best-effort basis with the remote XSP storage 24. However, from time to time non-authoritative and/or temporarily authoritative copies of the elements 18 may be stored in a local disk 826 associated with the user 12 on a cache controlled basis. The nature of the storage mechanism and cooperation between the network volumes 24 and the local volumes 26 will be discussed in greater detail below.

Associated with the XSP is a configuration manager 20 as has been previously described. The configuration manager 20 maintains a number of different data structures in order to support the coordination of a configuration according to the present invention.

First, a set of version vectors 50 are associated with the applications and/or content to be managed. For example, one version vector 50-1 contains a list of compatible applications, in other words, one possible compatible configuration of elements 18 to be managed. The entries in the version vector 50 indicate a particular version of the operating system 18-1, Microsoft Word Application 18-2 and Corel Word Perfect version 18-3 that are compatible with one another.

There may be a relatively large number of version vectors 50 associated with many different combinations of deployment of resources 18. However, version vectors 50 contain information such that particular combinations of resources 18 will not be associated with one another that are not compatible with each other. This information can be obtained from the software producers 14 themselves upon initial configuration of the version vectors 50. However, other version vectors may be formed in response to the experience of a particular XSP upon the attempt to deploy certain combinations of particular resources 18.

A version vector 50 is selected upon a particular request by a user 12 for participation in a service. For example, user 12 may request that any given access to a copy of the Windows Operating System, a Microsoft Word word processor and a document management program configuration 18-4. The configuration vectors 50 will then be searched for compatible versions of each of the requested resources. In general, the user will be given access to the most recent version of a combination of resources that are compatible with one another. However, if a particular resource 18 is not compatible with later versions of particular other resources 18, then a different version vector will be assigned to the user.

For example, it may be the case that the available version 1.1 of the document management software is not compatible with any version of Microsoft Word but is compatible with a number of different versions of Word Perfect 18-3. The version vector 500-n will be created in such a way that if the user requests the version 1.1 of the document management software they will not be allowed to install any version of Microsoft Word 18-2, and will be asked to install Word Perfect instead. While also being given the opportunity to also upgrade to a version of the document management application 18-4, such as version 2.1, which is compatible with Microsoft Word 18-2. If the upgrade is selected, version vector 50-n will then be associated with the user.

In another instance, a managed resource may be a particular database program 18-5, the user may have deployed an application such as an interface to a peripheral such as a hand held Palm Pilot 31 through which he attempts to access current data stored in the database 18-5. An earlier version 97 of the database 18-5 may have appropriate driver software for the Palm Pilot 31. However, the user may, upon making a request for service to the XSP, specify that he wishes to have the most recent version 2000 of the database 18-5 which is not compatible with the driver s/w for the Palm Pilot 31. The version vectors 50 will have captured the information that the most recent version of 2000 of the database 18-5 does not have compatible drivers for the Palm Pilot 31. In other words, a Palm Pilot driver 18-6 does not exist that is compatible with the most recent version of the database 18-5. Thus, the version vectors will serve as a mechanism to enforce a configuration whereby even though the user requests the version 2000 of the database 18-5, the version 97 will be used that is compatible with the Palm Pilot drivers 18-6 that he must also install.

The configuration manager 20 also maintains service profile information 60 associated with each user 12. Such service profile information 60 may include control attributes 61, purchase option information 62-1, 62-2, . . . 62-N for each of the N applications requested by the user, as well as administrative preference information 63.

The control attribute 61 may indicate to what extent the user wishes to give up control over his local file system 26. While this will be understood in more detail shortly, particular users 12 may wish to retain control over installation of certain resources 18. For example, a particular user may wish to control the installation of a word processor 18-2, but would provide the system with control over various other attributes such as the operating system and other applications.

The purchase options 62 indicate for each particular user 12, the manner in which the cost associated with a resource should be administered. For example, one particular application, such as the operating system 18-1 may be purchased by the user on a per machine basis. However, other applications such as the Word Perfect word processing application 18-3 may be such that the user wishes to have them installed but accessible only on a per access basis. Thus, for example, the user may need only to use Word Perfect once in a while but may wish to have access and is willing to pay for access to it on a per use, per day or per hour or other pro rata basis. Information associated with a particular subscription for a particular resource 18, is thus maintained in this purchase option field within the users' service profile 60.

Other information such as administrative preferences 63 may be associated with each user's service profile. Particularly, a given user may want to be more involved with selection of how the system 12 as a whole operates. As version conflicts and/or options such as the ability to upgrade to new versions or editions of resources become available and/or necessary, the user may prefer to be interrupted and prompted. On the other hand, other users may wish to simply have the system default to a particular function such as installing such requested upgrades as they become available and/or functionality as it is requested.

Finally it should be noted that the configuration manager 20 also maintains different versions of resources such as content file formats and types. For example, one user 12 may have particular older versions of software installed that can support multi-media content files only of an older type such as the Motion Picture Expert Group Version 2 (MPEG-2) type multi-media files and older audio files such as only .WAV type audio files. This information would be indicated with an entry 71 -1 associated with the file format vector 70 and/or the user service profile 60.

Other users that have installed more recent versions of an operating system and application software that have the ability to handle later generation content filed including MPEG-4 video files and MP3 type audio files respectively. As will be understood shortly, having this information available in the user service profile 60 and/or in the file format vector can contribute to further compatible and coordinated operation of applications.

Upon instantiation, the configuration manager 20 not only maintains configuration information for its user 12 as has been described above but also performs other functionality associated with any sort of service provided to a number of users in a data processing system. For example, these functions may include user authentication, authorization, and accounting for the services in a manner that is known in the art.

In addition, the XSP distribution model can be used to provide for service patches associated with particular modifications to installed versions. For example, when a software producer 14 releases a service patch 18-P for a particular resource 18, the service patch 18-P can be stored as another resource with its distribution managed among a number of users 12 in the same manner in which the resources 18 themselves are distributed among the users. Version vectors 50 may be created which provide for proper configuration of and distribution of the service patch 18-P to only those users and their configurations that can properly support the patch.

It should be understood that the user 12 may be typically a home based user or personal computer user that has only limited bandwidth access to the XSP such as through a dial up connection through the network 30. However, the invention can be used to advantage even in a business environment, such as where a small business contains only a small number of unsophisticated computer users or in a satellite office of a larger organization that does not have information technology professionals available to administer version distribution and compatibility among applications. Other business users may seldom connect to a corporate enterprise, such as in the case of sales professionals that are highly mobile and typically using laptop computing equipment. These users are also not necessarily easily subjected to configuration control procedures as in the same manner as the home office desk top computer users.

Proper implementation of a configuration management service in this manner however requires also cooperation of the management of content storage at the user side 12 especially within the local storage 26. In particular, processing elements at the user 12 must also ensure that correct versions of resources 18 are made available for the user 12. These elements cooperate with the configuration manager 20 to ensure that configuration management information is maintained, state information is maintained in persistent storage, and otherwise manage access to the resources 18 in a manner which is as transparent as possible to legacy application programs within the user 12.

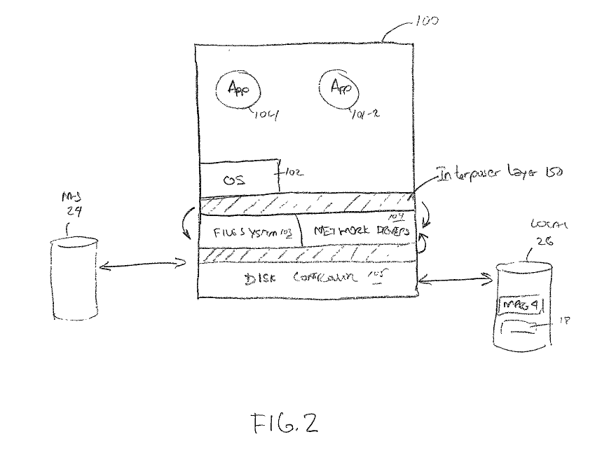

The operating system, file system, and network drivers do not need to be modified at the client 12, as shown in FIG. 2. In a data processing system 100 instantiated at the user 12 a number of application programs 101-1 and 101-2 are executing in the user memory space. An operating system 102 also contains the typical elements such as a file system 103, network drivers 104 and disk controller 105. The file system 103 and network drivers 104 operate as in the prior art.

The invention adds an interposer layer 150 to the operating system 102. The interposer layer 150 performs a number of functions as described below. Principally, the interposer layer 150 is cognizant of the configuration management 20 process that is running in the server 10 at the XSP. When the operating system 102 attempts to instantiate an application it first runs a loader program that asks the file system 103 to locate the specific disk blocks in which the application 101 is stored. The interposer layer 150 intercepts these requests to load and run applications 101. The interposer layer 150 then ensures that only a copy of a compatible version of the requested application is provided for running as requested even though such application may not be necessarily be present on the local disk 26 at the time the running is requested.

The interposer layer 150 thus intercepts all requests to the disk controller 105 through the file system 103, and finds the requested block in cooperation with the authoritative storage device provided by the network file system 24. For example, if the requested block is stored at the local disk 26 it is obtained by request to the disk controller 105. However, if the requested block is remote, it is fetched through the network drivers and the network file system 24. In effect the machine is converted to be a machine that can take advantage of the network file system 24 even if it is not initially configured that way. By the expedient of the interposer layer, this interception request occurs transparently for any existing software.

When the interposer layer 150 needs access to an application stored in the network file system 24, the configuration manager 20 then authenticates authorized accounts for the requested resource 18. Once these processes have been completed the interposer layer 150 then permits the processor 100 to actually execute the application 101. It should be understood that the local storage 26 and the network file server 24 cooperate in a manner that is also transparent to the applications 101. For example, they operate as a coordinated hierarchical cache system whereby authoritative copies of the resources 18 are only located at the NFS 24, but also can be pushed out to the local storage at the clients 12.

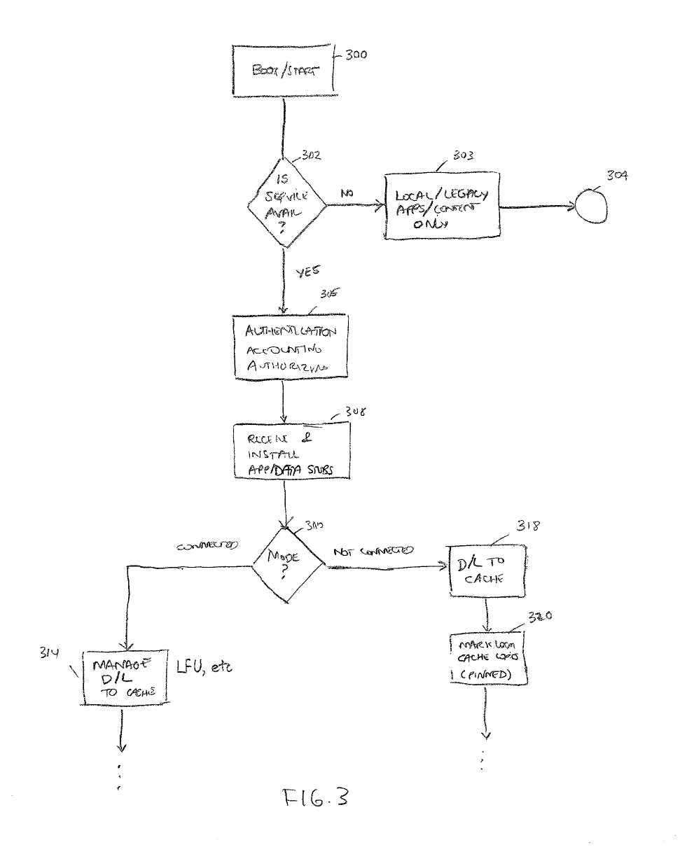

FIG. 3 is a more detailed flow chart of the sequence of steps performed by the interposer layer 150. Beginning from an initial boot and/or start state 300 the interposer layer 150 first determines, in state 302, if the configuration service is available. If it is not, then processing continues to a state 303 where the legacy and/or locally installed applications are and/or content are handled as in the prior art.

However, should the service distribution mechanism be available in accordance with the present invention, then a state 305 is entered in which the aforementioned authentication, accounting and authorization procedures proceed. Upon successful completion of these procedures between the interposer layer 150 and the configuration manager 20 at the XSP 20, a state 308 is entered in which resource stub information is received. The stub information for the requested resources 18 will be a minimal indication of where the interposer layer 150 can locate the requested resources 18 at a later time such as one or more file locators for data stored in the network file system 24 associated with the requested one or more resources 18.

The stubs are then installed in a manner so that to the user it appears as though an application, for example, Microsoft Word, has already been installed on their client computer 12, but in effect the copies of the application software are not on the local disk 26 but all stored on the network file server 24 only.

In step 310 a mode determination is made to determine a manner of execution of the service. If the user is expected to remain connected to the network 30 then a state 312 is entered in which the local storage is treated as a pure cache. Thus, any copy of a resource 18 stored in a local disk 26 will be considered to be a cache copy that can be evicted by the interposer to make room for new resources as needed. The corresponding authoritative copy remains within the higher level cache located at the NFS 24.

A state 314 is then entered in which the interposer layer 150 manages downloading of the requested resources 18 in a manner which is consistent with the availability of the network bandwidth and available storage in the local cache memory 26. Decisions about cache can be made based upon desired performance. For example, and algorithm such as Least Frequently Used (LFU) can be used to eject content that has been previously downloaded from the local cache 26. For more information on the cooperation between the network cache and/or network file system elements 24 and local storage 26 reference can be had to a U.S. Pat. No. 6,205,481 filed Mar. 17, 1998 entitled “Protocol For Distributing Fresh Content Among Networked Cache Servers,” and assigned to the InfoLibria Inc., the assignee of the present invention, which is incorporated herein by reference.

Returning attention to state 310, if the selected mode is such that the user device 12 is not expected to remain connected to the network, then a state 318 is entered in which the requested resources are downloaded to the local memory 26 and pinned in it. As much of the requested resources 18 will be allowed to be downloaded until such time as the local storage 26 becomes full. While this is happening the local copies will be marked as pinned since the network connection will not be made available on a continuous basis. This prevents the interposer from evicting the pinned resources. Should there be less available local storage space than is required to store all of the requested resources according to the corresponding users version vector 50 than the user may be prompted to prioritize and/or select from the available resources.

For example, if there is not enough room to store both copies of Microsoft Word and Corel WordPerfect at the user's local disk 26 the user may be prompted to select one word processor or another. This selection and/or other prompting of the user can be kept in the administrative preferences section 63 of the user's service profile 60.

Execution of an application 101 that has been installed in this fashion will continue in a manner which is transparent to the user but may involve further downloading or management and coordination of various parts of the resource 18 among the local storage 26 and network file system 24. This may require the interposer layer 150 to access certain elements of a resource 18 through the network drivers 104 as opposed to the file system 103 in certain images when certain requested portions or disk blocks of a resource 18 are not available on the local storage 26 but only at the NFS 24. However, it should be understood that the interposer layer 150 manages this request and coordinates it in a manner in which is transparent to the applications 101 and/or operating system 102 itself.

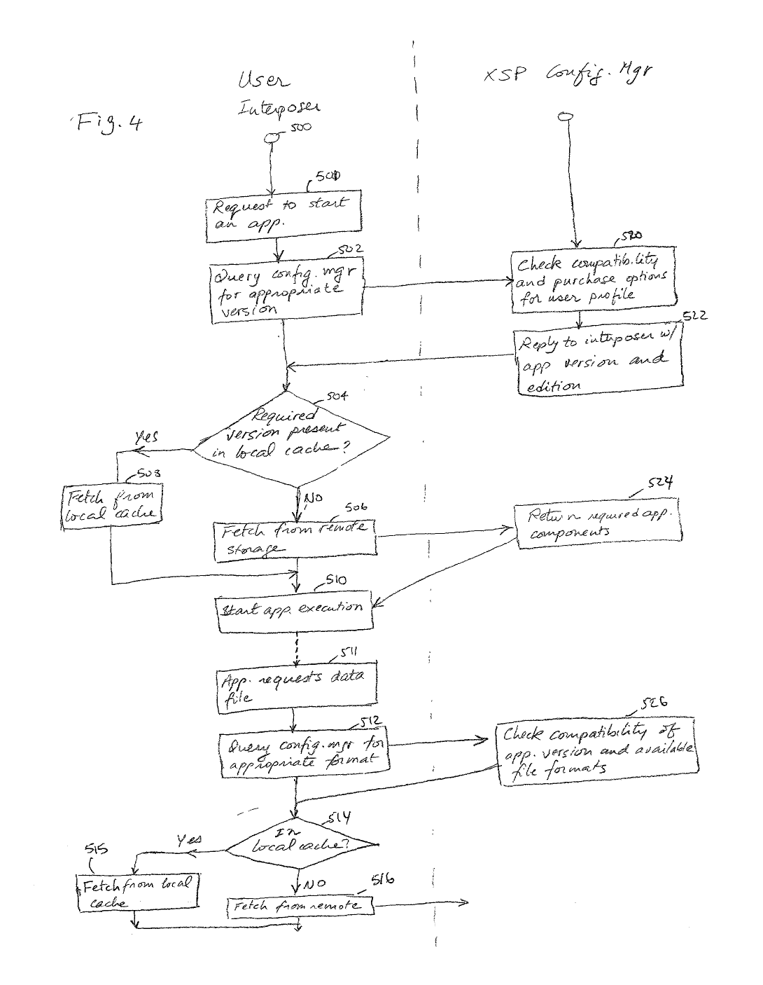

FIG. 4 is a block diagram of a process executed by the interposer 150 and configuration manager 20. From an initial idle state 500, the interposer receives a request to start an application in state 501. The configuration manager 20 is then queried in state 502 for an appropriate version of the application. The configuration manager in state 520 then checks the compatibility and purchase options associated with the user profile for the requested application. In state 522, a reply is provided to the interposer with the application version and edition information.

In state 504, the interposer then determines if the required version is present in its local cache 26. If so, then the application can be fetched from the local cache. If not, in state 506, the application must be fetched from remote network storage 24. The configuration manager 20 participates in this process as needed in state 524, returning required application components in utilizing elements of the network file system.

Eventually, in state 510, application execution can begin. Should a state 511 be reached in which an application requests the data file, the configuration manager can be queried in state 512 for an appropriate format. This request will be intercepted by the interposer with a message to the configuration manager in state 526 to determine compatibility of the application version and the available file formats. If they are available on state 514, then they are fetched from the local cache. If not, in state 516 they are fetched from the remote storage.

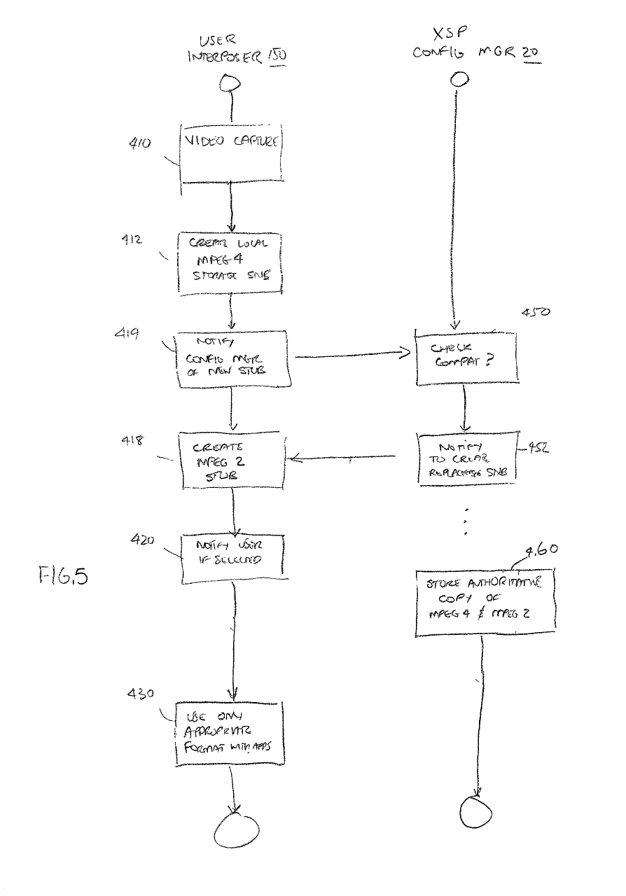

The invention can also be used to configure and/or manage the configuration of particular application programs and the particular data files that they create. For example, consider a situation in which a user 12 has connected a video capture device that begins storing output of a video camera as a highly compressed MPEG-4 type file. Turning attention to FIG. 5, the executes the video capture program 410 and starts creating a local MPEG-4 file from a video camera input. In state 412 however, the interposer layer 150 will intercept the request to access local storage 26 when the video camera driver first attempts to create the MPEG-4 file, and create a stub for it. The interposer layer 150 in state 414 will then also notify the configuration manager 20 of the creation of the new stub. The configuration manager 20, running in the XSP, in state 450 will check the compatibility of the MPEG-4 format of the new stub with the existing installed applications on the user 12. This can be done by examining the file format vector 70. If the version vector 70 indicates that MPEG-4 is not compatible with versions of multimedia software associated with the particular user 12, a state 452 is entered in which the configuration manager 20 notifies the interposer 150 to create a compatible replacement stub such as an MPEG-2 stub.

In state 418 the user interposer layer 150 receives this request and creates the MPEG-2 stub. The MPEG-2 stub may be created automatically or in a state 420 notify the user if he wishes to have it created. In any event the processing proceeds at both the user interposer layer 150 and at the configuration manager layer 20 so that the following sequence of events occurs. In particular, in state 460 authoritative copies of both the MPEG-4 content as provided by the video capture application are provided to the configuration manager 20 and stored in network file system 24. In addition the configuration manager 20 will execute a conversion process that creates an MPEG-2 version of the MPEG-4 file that is compatible with versions of the installed software resources 18. Thus, without intervention by the user 12, both the original version and a compatible version of the captured video file will be stored. The conversion can also be done on the user's processor.

In state 462 the MPEG-2 converted version will be implicitly labeled as appropriate for applications to be run by this particular user 12. As a result, in later states 430 application programs that are running on the user 12 will be intercepted by the user interposer 150 in such a way that only the appropriate MPEG-2 version for the applications installed on this particular machine, will be accessed.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for managing a data processing system comprising the steps of:
maintaining configuration management information at a central service provider location, the configuration management information representing combinations of compatible versions of particular resources to be deployed within the distributed data processing system; and
a distributed networking file server having portions associated with a service provider and other portions associated with a user client side deployment, distribution of resources being made by the file server in a manner such that the users obtain only access to compatible versions of different resources and whereby user access to the compatible versions is coordinated among distributed cache system.

2. A method as in claim 1 wherein the resources are software programs.

3. A method as in claim 1 wherein the resources are application programs.

4. A method as in claim 1 wherein the resources are operating system programs.

5. A method as in claim 1 wherein the resources are data files.

6. A method as in claim 1 wherein configuration management information includes information regarding a type of purchase options for the resource.

7. A method as in claim 5 where the identified purchase options are selected from a group consisting of a per license copy, per usage, and periodic subscription.

8. A method as in claim 1, such that execution of the applications is controlled at the user side of the system whereas distribution of the applications is controlled form a network side.

9. A method as in claim 8 wherein execution of the applications may occur by the user processor accessing resources located at the network file server or local file cache location in a manner which is transparent to the execution of the resources themselves at the user.

10. A system for distribution of computing resources comprising:
(c) a local storage device located at a client processor, for serving computing resources;
(b) an interposer executing on the client processor, for intercepting requests for resources, and for referring such requests to a configuration manager, and receiving instructions for accessing copies of the resources from such resource manager;
(c) a configuration manager, located at a service provider node, for (i) maintaining resource version compatibility vector, (ii) maintaining a use profile of resource selections, (iii) receiving requests for specific resources from an interposer, and (iv) responding with instructions for how to store a resource version compatible with other resource versions used by the client in the local storage device.

11. An apparatus as in claim 10 wherein the resources are application programs.

12. An apparatus as in claim 10 wherein the resources are data.

13. An apparatus as in claim 10 additionally comprising:
a network storage device, for storing a superset of a plurality of versions for each of multiple resources, the network storage device coordinating distribution and selected resource versions to the local storage device.

14. An apparatus as in claim 11 wherein the version compatibility vector specifies compatibility between two application programs.

15. An apparatus as in claim 10 wherein the resource include both application programs and data.

16. An apparatus as in claim 15 wherein the compatibility vector specifies compatibility between a data format and an application that uses it.

17. An apparatus as in claim 16 wherein the interposer additionally intercepts requests for access to data resources and, cooperating with the configuration manager, effects conversion of data resources to a format compatible with selected application.

18. An apparatus as in claim 10 wherein the interposer associates correct versions of resources in the local cache for use while the client processor is disconnected from the configuration manager.

19. An apparatus as in claim 11 wherein the resources are different editions of application programs.
